(19) United States
(12) Patent Application Publication
(10) Pub. No.: US 2004/0041832 A1
(43) Pub. Date: Mar. 4, 2004

(54) Method and system for displaying information at a remote display device

(76) Inventors: Tuyet-Huong Thi Nguyen, Austin, TX (US); Wai-Ming Richard Chan, Austin, TX (US)

Correspondence Address: HAMILTON & TERRILE, LLP, P.O. BOX 203518, AUSTIN, TX, 78720, US

(21) Appl. No.: 10/231,768

(22) Filed: Aug. 28, 2002

(51) Int. Cl. G09G 5/00

(52) U.S. Cl. 345/736; 345/740

(57) ABSTRACT

A method and system for displaying information at a remote display device from an information processing system that lacks video display components causes the information processing system to initiate system memory to store video information despite the lack of video components, thus allowing applications to write display information to the system memory and allowing the information handling system to re-direct the display information to the remote display. For instance, the information handling system BIOS includes a video function module that detects a lack of video display components, determines that the information handling system is a headless server, and initiates system memory to store video information. A remote display module associated with the BIOS monitors the system memory and re-directs detected display information stored in the system memory to a remote information handling system that displays the information.

### BACKGROUND OF THE INVENTION

1. Field of the Invention

The present invention relates in general to the field of information processing, and more particularly to a method and system for displaying information associated with an information handling system at a remote display device.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

One type of information handling system is a server, which generally processes network information to support clients interfaced with the network. Servers handle a range of functions such as maintaining and running applications for businesses, storing data, handling Internet access, handling e-mails, etc. . . . However, servers have become increasingly specialized to address specific network processing goals with server manufacturers working towards server designs that minimize footprint and cost. For instance, servers are sometimes installed as “headless” servers that operate without local display and input devices. Since the server's primary function is to process network information, display and input devices are typically not used very often with the server so that excluding display and input devices from the server results in substantial space and cost savings with minimal impact on the performance of server functions. When user interaction with a headless server is desired or needed, users typically communicate with the headless server through a remote device, such as an information handling system interfaced with the headless server through a network port, serial port, or other input/output port.

Typically, the basic input/output system (BIOS) of a headless server supports communication with remote devices by re-directing information for display to the remote device and receiving keystrokes from the remote device through the network, serial or other input/output port. For instance, the BIOS may monitor calls by application programs for INT 10h, a video BIOS Service Interrupt handler used by application programs for all video functions, which results in the writing of display information by an application program to video memory. When an application program calls INT 10h to display a character on a display, the Video BIOS Service Interrupt handler normally writes the character and its attributes to video memory, such as memory that resides on a VGA card, resulting in the display of the character. However, when a headless server BIOS detects a call for INT 10h, the headless server BIOS traps the INT 10h call to redirect the display information to the remote device.

One difficulty with displaying information generated by local applications running on a headless server is that some applications are able to write display information directly to video memory without calling INT 10h. On non-headless servers that are equipped with video memory, the BIOS monitors the video memory, detects changes and re-directs the display accordingly. Since headless servers lack display components such as VGA hardware, display information written by applications directly to video memory is typically lost. The headless server BIOS generally cannot monitor video memory for changes to re-direct display information written directly to video memory. Thus, display information generated by application programs that write directly to video memory is generally not available for display on a remote device.

### SUMMARY OF THE INVENTION

Therefore a need has arisen for a method and system which re-directs display information from an information handling system that lacks video components to a remote device for display of the information.

A further need exists for a method and system which efficiently monitors a headless server to identify display information and re-directs the display information to a remote device.

In accordance with the present invention, a method and system are provided which substantially reduce the disadvantages and problems associated with previous methods and systems for displaying information from an information handling system at a remote device. The information handling system initializes system memory to appear as video memory when video components are absent if the information handling system functions with display of information at a remote device. The information handling system monitors system memory for video information and, if a change is detected in the system memory that indicates the storing of display information, the information handling system re-directs the display information to a remote device.

More specifically, a video function module associated with a headless server BIOS determines upon power up of the headless server that the headless server lacks video display components and that the headless server functions with the display of information at a remote display device. The video function module then initializes system memory of the headless server so that display information written by local applications is written to system memory. A remote display module associated with the headless server BIOS monitors the system memory for changes in the stored data that indicates the storing of display information, such as display characters, and redirects the display information to a remote display device, such as an information handling system, for display of the information. Display information written by program applications with an INT 10h call or written directly to system memory are each detected with a single monitoring technique of monitoring changes to system memory to detect the writing of display information.

The present invention provides a number of important technical advantages. One example of an important technical advantage is that display information is redirected from an information handling system that lacks video components, such as a headless server, to a remote device for display of the information. The video function module essentially tricks the information handling system into seeing video memory by initializing system memory in the absence of video display components if the information handling system performs a function that displays information at a remote device. For instance, a headless server initializes system memory for accepting display information even though the headless server lacks video components so that display information generated by applications is stored in system memory and available for re-direction to a remote display device. Thus, display information from applications that write with a BIOS interrupt or directly to system memory are each available at a remote device.

Another example of an important technical advantage of the present invention is that the remote display module efficiently monitors a headless server to identify display information and re-direct the display information to a remote device. For instance, applications that write display information with an INT 10h call or by writing directly to video memory are each monitored with the same process of detecting changes to system memory to detect the storing of display information. If a change is detected to the information in system memory, the updated display information is sent to the remote device for display. The use of a single process for detecting display information efficiently monitors different types of local applications running on the headless server.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts a block diagram of an information handling system configured as a headless server; and

FIG. 2 depicts a flow diagram for a process of initializing system memory of an information handling system to store display information in the absence of video components.

### DETAILED DESCRIPTION

In order to display information at a remote device from an information handling system that lacks video display components, the information handling system is essentially tricked into seeing video components so that system memory of the information handling system is initialized to store video information as video memory. Once system memory is initialized to store video information, changes to system memory are detected to indicate the presence of display information and the display information is then re-directed to a remote display device. For purposes of this application, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

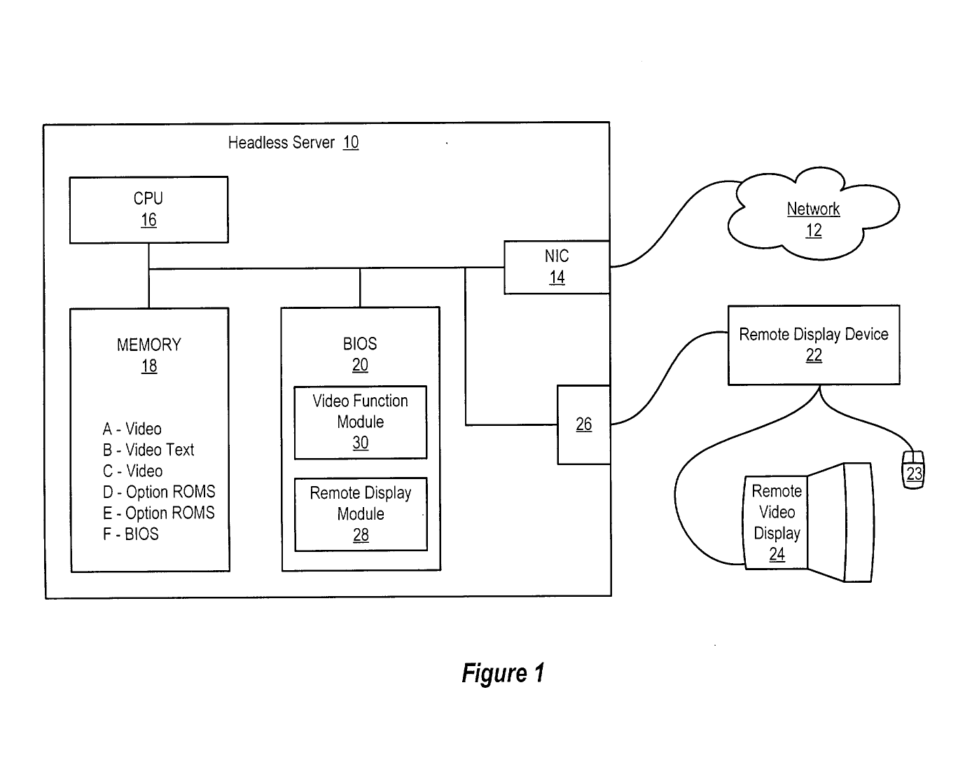

Referring now to FIG. 1, a block diagram depicts one embodiment of a system for displaying information from an information handling system at a remote display device. A headless server 10 supports client information handling systems interfaced with a network 12 through one or more network interface cards 14. Headless server 10 includes one or more CPUs 16, local memory 18 and a BIOS 20. However, headless server 10 lacks video display components to support a local video display, such as VGA hardware, and also lacks local input devices, such as a keyboard or mouse. Headless server 10 has a reduced size and cost since chipset and other components that normally support information handling system operations relating to display and input of information are not included. Instead, headless server 10 presents display information and accepts user inputs through a remote display device 22 that supports a remote input device 23 and remote video display 24. For instance, a personal computer remote display device 22 interfaces with headless server 10 through a serial port 26 or through network 14 to accept inputs for headless server 10 with a remote input device 23, such as a mouse or keyboard, and to present display information through a video display 24.

CPU 16's primary function is to process network information as a network server. However, in some circumstances, CPU 16 runs local applications that generate local information for display by remote video display 24 and that accept user inputs through remote input device 23. Local applications write local display information to system memory 18 by either performing a video BIOS service interrupt call (INT 10h) or by writing the local display information to the system memory range of A0000h-BFFFFh from the A through F ranges defined for video information with AT compatible information handling systems. BIOS 20 includes a remote display module 28 that monitors system memory 18 in the video memory range and, when a change in the system memory is detected that indicates the storing of display information, sends the updated display information to remote video display 24. By monitoring the video memory for changes, remote display module 28 detects local video display information written by either a video BIOS service interrupt call or an application that writes directly to the video memory, and re-directs the display information to remote display device 22.

Local applications running on CPU 16 that attempt to write display information directly to video memory will have that display information lost if video memory is not initiated. To support the direct writing of display information to video memory by local applications, a video function module 30 of BIOS 20 initiates video memory within system memory 18 so that video information written directly to video memory is stored. Video function module 30 detects the lack of video display components associated with headless server 10, such as during power up of headless server 10, and initiates system memory to accept local display information written directly from applications running on CPU 16.

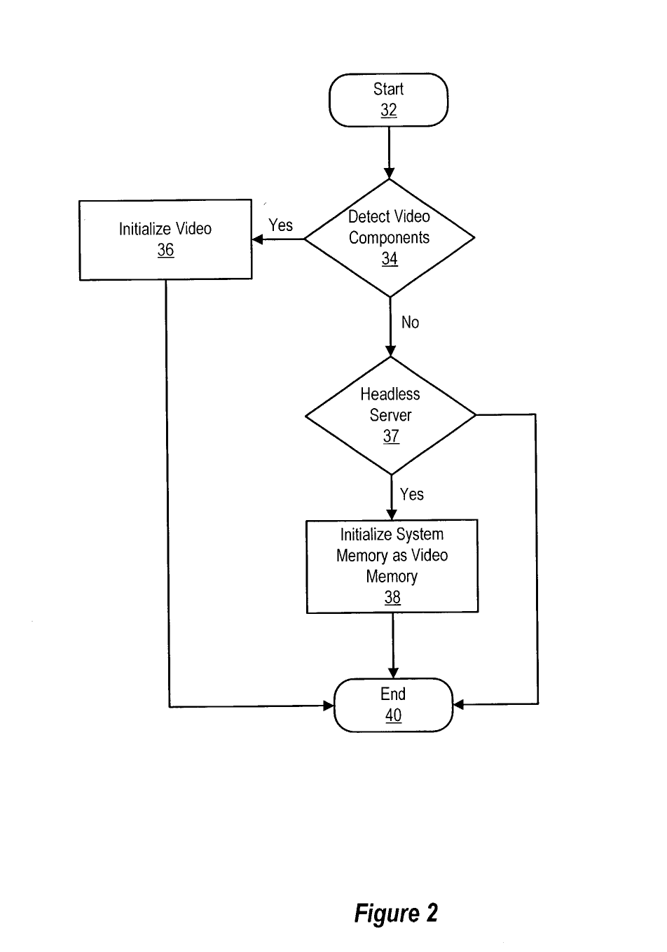

Referring now to FIG. 2, a flow diagram depicts one embodiment of a process that initiates system memory to store local display information when video display components are absent or not detected. The process begins with power up of web server 10 at step 32, although, in alternative embodiments, the process may start after power up is complete. At step 34, a determination is made of whether video components are detected. Video components may include graphics cards with separate memory, graphics controllers included in the chipset, or other components that support the display of video information through a display interfaced with web server 10. If video components are detected at step 34, the process proceeds to step 36 for initialization of the video components and ends at step 40 after which the information handling system may proceed in a normal boot.

If no video components are detected at step 34, the process proceeds to step 37 for a determination of whether the information handling system is a headless server. If the determination at step 37 is yes that the information handling system is a headless server, then the process proceeds to step 38 for initialization of system memory as video memory. If the determination at step 37 is no that the information handling system is not a headless server, then the process ends at step 40 after which the information handling system may proceed with a normal boot without initialization of video memory. At step 38, initialization of system memory as video memory essentially tricks a headless server into finding that video components exist so that boot proceeds without generating errors associated with a failure to detect video components. In contrast, if at step 37 a determination is made that the information handling system is not a headless server, the BIOS proceeds with boot at step 40 based on a failure to detect video components. In alternative embodiments, step 37 may detect alternative types of information handling systems that initiate system memory at A0000-BFFFF despite the absence of video display components in order to present display information through remote display devices.

Although the present invention has been described in detail, it should be understood that various changes, substitutions and alterations can be made hereto without departing from the spirit and scope of the invention as defined by the appended claims.

What is claimed is:

1. An information handling system comprising:
one or more central processing units operational to generate information for display;
a basic input/output system interfaced with the central processing unit; and
a video function module associated with the basic input/output system and operational upon power up of the information handling system to determine a lack of video display components, to determine that the information handling system displays information at a remote display device, and to initialize system memory of the information handling system to store video information.

2. The information handling system of claim 1 further comprising network interfaces operational to support headless server functions.

3. The information handling system of claim 1 further comprising a remote display module associated with the basic input/output system and operational to monitor system memory for display information and to re-direct the display information to a remote display device.

4. The information handling system of claim 3 further comprising an application running on the central processing unit, the application writing display information by calling a video basic input/output service interrupt handler.

5. The information handling system of claim 3 further comprising an application running on the central processing unit, the application writing display information directly to system memory.

6. The information handling system of claim 3 wherein the remote display module is further operational to receive keystroke information from the remote display device.

7. The information handling system of claim 3 further comprising a serial port interfaced with the remote display device, the remote display device comprising an information handling system having video display components.

8. A method for displaying information, the method comprising:
powering up an information handling system;
determining that the information handling system lacks video display components;
determining that the information handling system displays information at a remote display device;
initializing system memory of the information handling system to store video information; and
re-directing video information written to the system memory to a remote display device.

9. The method of claim 8 wherein the information handling system comprises a headless server.

10. The method of claim 8 further comprising:
running an application on the information handling system; and
monitoring the system memory to detect information for display on the remote display device.

11. The method of claim 10 further comprising:
detecting information written to the system memory by an application that calls a video BIOS service interrupt.

12. The method of claim 10 further comprising:
detecting information written to the system memory by an application that writes display information directly to the system memory.

13. The method of claim 9 wherein the remote display device comprises an information handling system interfaced with the headless server.

14. A headless server comprising:
one or more CPUs for processing network information running local applications, the local applications generating local display information;
one or more network connectors interfaced with the CPU and operable to communicate network information;
a BIOS interfaced with the CPU;
system memory interfaced with the CPU and BIOS and operable to store information; and
a video function module associated with the BIOS, the video function module operable to determine a lack of display components included with the headless server and to initiate system memory to store local display information.

15. The headless server of claim 14 further comprising a remote display module associated with the BIOS, the remote display module monitoring system memory to detect local display information stored in the system memory.

16. The headless server of claim 15 further comprising a remote display device interfaced with the headless server and wherein the remote display module re-directs local display information stored in the system memory to the remote display device.

17. The headless server of claim 16 wherein the remote display device comprises an information handling system interfaced with the headless server through a serial port.

18. The headless server of claim 15 wherein the local application comprises an application that writes display information directly to video memory.

19. The headless server of claim 15 wherein the local application comprises an application that writes display information by calling a video BIOS interrupt.

20. The headless server of claim 16 wherein the remote display module accepts inputs from the remote display device for the local application.
